(19) United States
(12) Patent Application Publication
(10) Pub. No.: US 2018/0122025 A1
(43) Pub. Date: May 3, 2018

(54) Wireless earpiece with a legal engine

(71) Applicant: BRAGI GmbH, Munchen (DE)

(72) Inventor: Peter Vincent Boesen, Munchen (DE)

(73) Assignee: BRAGI GmbH, Munchen (DE)

(21) Appl. No.: 15/790,424

(22) Filed: Oct. 23, 2017

Related U.S. Application Data
(60) Provisional application No. 62/415,243, filed on Oct. 31, 2016.

(51) Int. Cl. G06Q 50/18; G06F 17/30; H04R 1/10

(52) U.S. Cl. CPC G06Q 50/18; H04R 2420/07; H04R 1/1016; G06F 17/30976

(57) ABSTRACT

A system, method, and wireless earpieces for implementing a legal assistant utilizing wireless earpieces. A request is received from a user to be implemented by wireless earpieces. A legal engine is executed on the wireless earpieces. Information associated with the request is retrieved from one or more legal databases accessible to the wireless earpieces. An action is implemented to fulfill the request utilizing the information through the legal assistant.

### PRIORITY STATEMENT

This application claims priority to U.S. Provisional Patent Application 62/415,243, filed on Oct. 31, 2016, and entitled Wireless earpiece with a legal engine, hereby incorporated by reference in its entirety.

### BACKGROUND

### I. Field of the Disclosure

The illustrative embodiments relate to wireless earpieces. More specifically, but not exclusively, the illustrative embodiments relate to a legal engine for wireless earpieces.

### II. Description of the Art

The growth of wearable devices is increasing exponentially. This growth is fostered by the decreasing size of microprocessors, circuity boards, chips, and other components. Thus far, wearable devices have been limited to basic components, functionality, and processes due to their limited footprint and space. At the same time, more and more users, have become dependent on network knowledge through virtual assistants, such as Siri, Alexa, Cortana, and so forth. Virtual assistants have not been fully integrated into wearables due to size constraints and available processing power.

### SUMMARY OF THE DISCLOSURE

One embodiment of the illustrative embodiments provides a system, method, and wireless earpieces for implementing a legal assistant utilizing wireless earpieces. A request is received from a user to be implemented by wireless earpieces. A legal engine is executed on the wireless earpieces. Information associated with the request is retrieved from one or more legal databases accessible to the wireless earpieces. An action is implemented to fulfill the request utilizing the information through the legal engine. Another embodiment provides wireless earpieces including a processor and a memory storing a set of instructions. The set of instructions are executed to perform the method described above.

Another embodiment provides a wireless earpiece. The wireless earpiece may include a frame for fitting in an ear of a user. The wireless earpiece may also include a logic engine controlling functionality of the wireless earpiece. The wireless earpiece may also include a number of sensors measuring biometrics and actions associated with the user. The number of sensors measure receive a request from the user to be implemented by the wireless earpiece. The wireless earpiece may also include a transceiver communicating with at least a wireless device. The logic engine executes a legal assistant on the wireless earpieces, retrieves information associated with the request from one or more legal databases accessible to the wireless earpieces, and implements an action to fulfill the request utilizing the information through the legal engine.

According to another aspect, a method for implementing a legal assistant utilizing wireless earpieces is provided. The method includes receiving a request from a user to be implemented by wireless earpieces, executing a legal assistant on the wireless earpieces to interpret the request and contextual data associated with the request into a query, retrieving information associated with the query from one or more legal databases accessible to the wireless earpieces, and implementing an action to fulfill the request utilizing the information through the legal engine. The contextual data may include sensor information including voice audio from at least one person other than the user detected at one or more microphones of the wireless earpieces, location of the user, and/or a court docket number identifying a case or other legal proceeding associated with the query. The contextual data may further include sensor information including voice audio from at least one person other than the user detected at one or more microphones of the wireless earpieces; and a court docket number identifying a case associated with the query.

According to another aspect, a method for implementing a legal assistant utilizing wireless earpieces is provided. The method includes providing a set of wireless earpieces wherein at least one of the wireless earpieces comprises a frame for fitting in an ear of a user, a plurality of sensors measuring biometrics and actions associated with the user, a logic engine operatively connected to the plurality of sensors and configured to execute a legal assistant, and a transceiver operatively connected to the logic engine. The method further includes collecting contextual data from the set of wireless earpieces using the plurality of sensors and from one or more additional electronic devices associated with the user, executing a legal assistant on the wireless earpieces to interpret the contextual data into a query, retrieving information associated with the query from one or more legal databases accessible to the wireless earpieces, and generating audio at the set of wireless earpieces to convey the information to the user. The contextual data may further include voice audio from at least one person other than the user detected at one or more microphones of the wireless earpieces, location of the user, and/or a court docket number identifying a legal proceeding. The method may further include making the user aware of the availability of the information and receiving permission form the user through the set of wireless earpieces to convey the information to the user via the audio.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a communication system in accordance with an illustrative embodiment;

FIG. 2 is a block diagram of wireless earpieces in accordance with an illustrative embodiment;

FIG. 3 is a pictorial representation of sensors of the wireless earpieces in accordance with illustrative embodiments;

FIG. 4 is a flowchart of a process for utilizing a legal engine for wireless earpieces in accordance with an illustrative embodiment;

FIG. 5 is a flowchart of a process for utilizing a legal engine for wireless earpieces and a wireless device in accordance with an illustrative embodiment;

FIG. 6 is a flowchart of a process for automatically implementing a legal engine in accordance with an illustrative embodiment;

FIG. 7 is a passive process for utilizing a legal engine in accordance with an illustrative embodiment; and

FIG. 8 depicts a computing system in accordance with an illustrative embodiment.

### DETAILED DESCRIPTION OF THE DISCLOSURE

The illustrative embodiments provide a system, method, wireless earpieces, and personal area network for providing a legal engine. In one embodiment, the wireless earpieces may independently execute a legal engine available to the user with or without a connection to another wireless device, such as a smart phone, tablet, or laptop. In another embodiment, the legal engine may be accessed through a separate wireless device with the wireless earpieces acting as an input/output device for providing voice, gesture, touch, or other input to control, manage, or interact with the legal engine.

The legal engine may operate actively or passively to perform any number of tasks, features, and functions based on a user request, user preferences, or so forth. The legal engine may represent hardware, software, firmware, or a combination thereof that may include systems of the wireless earpieces that may be utilized to implement the embodiments herein described. The legal engine may also be an integrated part of a virtual reality or augmented reality system.

The legal engine of the wireless earpieces may also be utilized to play music or audio, track user biometrics, perform communications (e.g., two-way, alerts, etc.), provide feedback/input, or perform any number of other tasks. In one embodiment, the legal engine may be utilized to monitor one or more additional users that may be proximate the user wearing the wireless earpieces. The legal engine may manage execution of software or sets of instructions stored in an on-board memory of the wireless earpieces to accomplish numerous tasks. The legal engine may also be utilized to control, communicate, manage, or interact with a number of other computing, communications, or wearable devices, equipment, systems, or software applications, such as smart phones, litigation software, laptops, personal computers, docketing systems, tablets, practice management software, holographic displays, virtual reality systems, gaming devices, projection systems, vehicles, smart glasses, helmets, smart glass, watches or wrist bands, chest straps, implants, displays, clothing, or so forth.

In one embodiment, the legal engine of the wireless earpieces may be integrated with, control, or otherwise communicate with a personal area network. A personal area network is a network for data transmissions among devices, such as personal computing, communications, camera, vehicles, entertainment, and medical devices. The personal area network may utilize any number of wired, wireless, or hybrid configurations and may be stationary or dynamic. For example, the personal area network may utilize wireless network protocols or standards, such as INSTEON, IrDA, Wireless USB, near field magnetic induction (NFMI), Bluetooth, Z-Wave, ZigBee, Wi-Fi, ANT+ or other applicable radio frequency signals. In one embodiment, the personal area network may move with the user. Any number of conditions, factors, and so forth may be utilized to determine a response or implementation of a command that is communicated to one or more of the wireless earpieces. The legal engine may provide a hands free way of receiving information (e.g., applicable to the user, user's environment, wireless earpieces, connected devices, etc.) and implementing and controlling functions and features. The wireless earpieces may utilize the legal engine to access a number of legal databases. For example, the legal engine may include any number of databases that may be accessed based on commands, keywords, phrases, user preferences, settings, or other information. In another example, the legal engine may utilize any number of virtual assistance to access legal databases that may be publicly available, subscription-based, privately accessible, or otherwise managed by individuals, companies, nonprofits, or other entities.

The wireless earpieces may include any number of sensors for reading user biometrics, such as pulse rate, blood pressure, blood oxygenation, temperature, orientation, calories expended, blood or sweat chemical content, voice and audio output, impact levels, and orientation (e.g., body, head, etc.). The sensors may also determine the user's location, position, heart rate, voice stress levels, and so forth. The sensors may also receive user input and convert the user input into commands or selections made across the personal devices of the personal area network. For example, the user input detected by the wireless earpieces may include voice commands, head motions, finger taps, finger swipes, motions or gestures, or other user inputs sensed by the wireless earpieces. The user input may be received, parsed, and converted into commands associated with the input that may be utilized internally by the wireless earpieces or sent to one or more external devices, such as a tablet computer, smart phone, laptop, or so forth. The wireless earpieces may perform sensor measurements for the user to read any number of user biometrics. The user biometrics may be analyzed including measuring deviations or changes of the sensor measurements over time, identifying trends of the sensor measurements, and comparing the sensor measurements to control data for the user.

The wireless earpieces may also measure environmental conditions, such as temperature, location, barometric pressure, humidity, radiation, wind speed, and other applicable environmental data. The wireless earpieces may also communicate with external devices to receive additional sensor measurements. The wireless earpieces may communicate with external devices to receive available information, which may include information received through one or more networks, such as the Internet.

The legal engine of the wireless earpieces may be particularly adapted to providing input for legal professionals, such as lawyers, paralegals, judges, transcriptionists, legal assistants, practice managers, and other parties that work in the legal field. The input may be provided in real-time through the wireless earpieces or may be sent to one or more connected devices. The wireless earpieces may also be activated to perform the illustrative embodiments even when they are not worn by the user. In one embodiment, the legal engine may access information and resources available through third parties or partners, such as IBM's Watson.

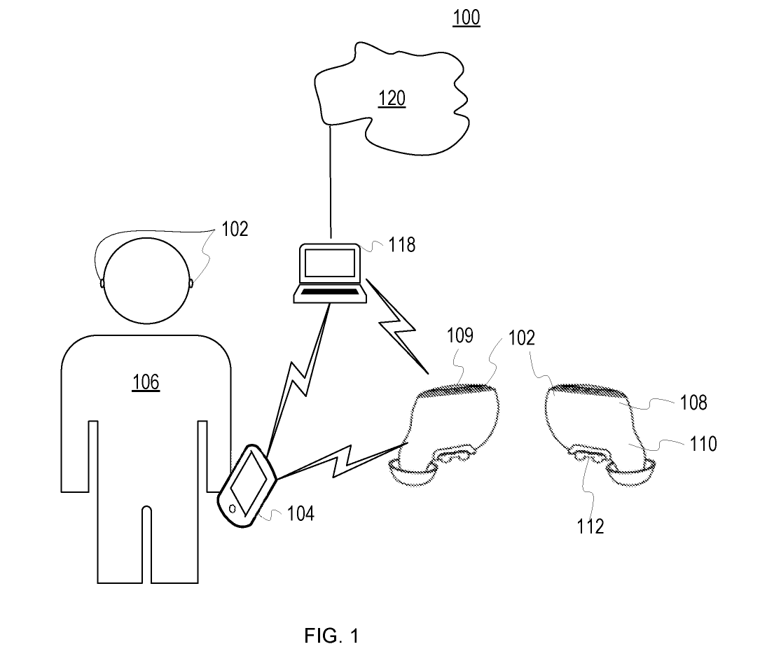

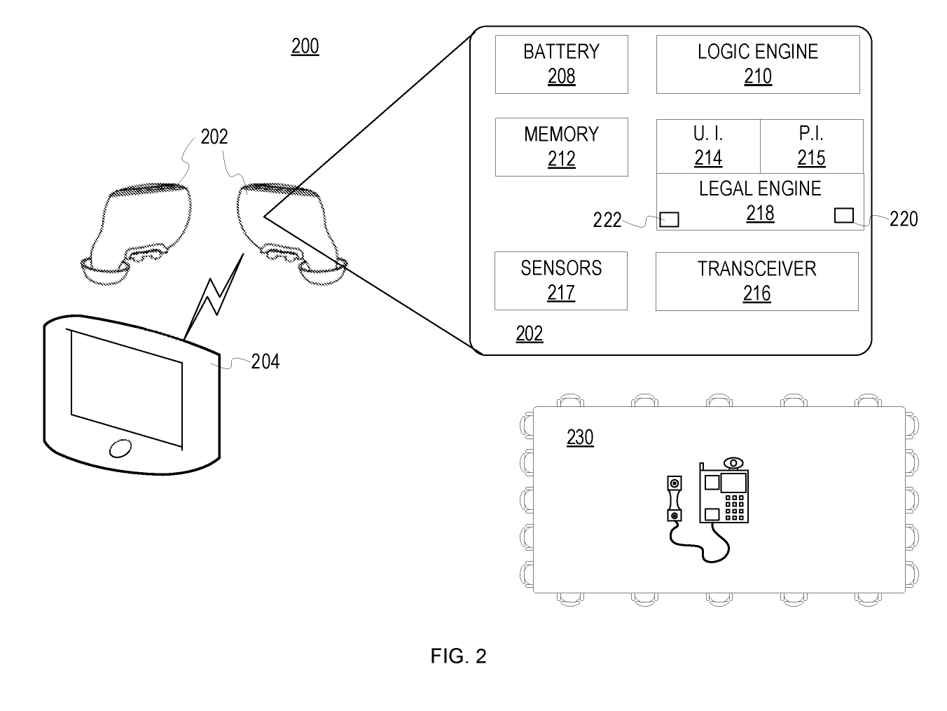

FIG. 1 is a pictorial representation of a communications environment 100 in accordance with an illustrative embodiment. The wireless earpieces 102 may be configured to communicate with each other and with one or more wireless devices, such as a wireless device 104 or a personal computer 118 (as well as the associated software including operating systems, kernels, applications, and so forth). The wireless earpieces 102 may be worn by a user 106 and are shown both as worn and separately from their positioning within the ears of the user 106 for purposes of visualization. A block diagram of the wireless earpieces 102 if further shown in FIG. 2 to further illustrate components and operation of the wireless earpieces 102 including the legal engine.

In one embodiment, the wireless earpieces 102 includes a frame 108 shaped to fit substantially within the ears of the user 106. The frame 108 is a support structure that at least partially encloses and houses the electronic components of the wireless earpieces 102. The frame 108 may be composed of a single structure or multiple structures that are interconnected. An exterior portion of the wireless earpieces 102 may include a first set of sensors shown as infrared sensors 109. The infrared sensors 109 may include emitter and receivers that detects and measures infrared light radiating from objects within its field of view. The infrared sensors 109 may detect gestures, touches, or other user input against an exterior portion of the wireless earpieces 102 that is visible when worn by the user 106. The infrared sensors 109 may also detect infrared light or motion. The infrared sensors 109 may be utilized to determine whether the wireless earpieces 102 are being worn, moved, approached by a user, set aside, stored in a smart case, placed in a dark environment, or so forth. In one embodiment, the user 106 may configure the wireless earpieces 102 for usage even when not worn, such as when placed on a desk or table or positioned within a smart case that charges, secures, and protects the wireless earpieces 102 when not in use.

The frame 108 defines an extension 110 configured to fit substantially within the ear of the user 106. The extension 110 may include one or more speakers or vibration components for interacting with the user 106. The extension 110 may be removable covered by one or more sleeves. The sleeves may be changed to fit the size and shape of the user's ears. The sleeves may come in various interchangeable sizes and may have extremely tight tolerances to fit the user 106 and one or more additional users that may utilize the wireless earpieces 102 during their expected lifecycle. In another embodiment, the sleeves may be custom built to support the interference fit utilized by the wireless earpieces 102 while also being comfortable while worn. The sleeves are shaped and configured to not cover various sensor devices of the wireless earpieces 102. In other embodiments, the wireless earpieces 102 may be docked with other devices utilized or worn by the user 106, such as watches, glasses, headsets, jewelry, smart phones, personal computers, gaming devices, or so forth.

In one embodiment, the frame 108 or the extension 110 (or other portions of the wireless earpieces 102) may include sensors 112 for sensing pulse, blood oxygenation, temperature, voice characteristics, skin conduction, glucose levels, impacts, activity level, position, location, orientation, as well as any number of internal or external user biometrics. In other embodiments, the sensors 112 may be positioned to contact or be proximate the epithelium of the external auditory canal or auricular region of the user's ears when worn. For example, the sensors 112 may represent various metallic sensor contacts, optical interfaces, or even micro-delivery systems for receiving, measuring, and delivering information and signals. Small electrical charges or spectroscopy emissions (e.g., various light wavelengths) may be utilized by the sensors 112 to analyze the biometrics of the user 106 including pulse, blood pressure, skin conductivity, blood analysis, sweat levels, and so forth. In one embodiment, the sensors 112 may include optical sensors that may emit and measure reflected light within the ears of the user 106 to measure any number of biometrics. The optical sensors may also be utilized as a second set of sensors to determine when the wireless earpieces 102 are in use, stored, charging, or otherwise positioned. The sensors 112 may include an array of components.

The sensors 112 may be utilized to provide relevant information that may be communicated through the legal engine. As described, the sensors 112 may include one or more microphones that may be integrated with the frame 108 or the extension of the wireless earpieces 102. For example, an external microphone may sense environmental noises as well as the user's voice as communicated through the air of the communications environment 100. The external microphones may sense additional user's voices to perform recordings, analysis, actions, or otherwise facilitate the activities of the user 106. An ear-bone or internal microphone may sense vibrations or sound waves communicated through the head of the user 102 (e.g., bone conduction, etc.).

In some applications, temporary adhesives or securing mechanisms (e.g., clamps, straps, lanyards, extenders, etc.) may be utilized to ensure that the wireless earpieces 102 remain in the ears of the user 106 even during the most rigorous or physical activities or to ensure that if they do fall out they are not lost or broken. For example, the wireless earpieces 102 may be utilized during marathons, swimming, team sports, biking, hiking, parachuting, or so forth. In one embodiment, miniature straps may attach to the wireless earpieces 102 with a clip on the strap securing the wireless earpieces to the clothes, hair, or body of the user. The wireless earpieces 102 may be configured to play music or audio, receive and make phone calls or other communications, determine ambient environmental conditions (e.g., temperature, altitude, location, speed, heading, etc.), read user biometrics (e.g., heart rate, motion, temperature, sleep, blood oxygenation, voice output, calories burned, forces experienced, etc.), and receive user input, feedback, or instructions. The wireless earpieces 102 may also execute any number of applications to perform specific purposes. The wireless earpieces 102 may be utilized with any number of automatic assistants, such as Siri, Cortana, Alexa, Google, Watson, or other smart assistants/artificial intelligence systems.

The communications environment 100 may further include the personal computer 118. The personal computer 118 may communicate with one or more wired or wireless networks, such as a network 120. The personal computer 118 may represent any number of devices, systems, equipment, or components, such as a laptop, server, tablet, transcription system, security system, gaming device, virtual/augmented reality system, or so forth. The personal computer 118 may communicate utilizing any number of standards, protocols, or processes. For example, the personal computer 118 may utilize a wired or wireless connection to communicate with the wireless earpieces 102, the wireless device 104, or other electronic devices. The personal computer 118 may utilize any number of memories or databases to store or synchronize biometric information associated with the user 106, data, passwords, or media content. The personal computer 118 may also include any number of legal databases, guides, journals, recorders, briefs, digital compilations and files, and networks such as LexisNexis, Westlaw, BNA, American Lawyer, Blomberg Law, Legal Reporters, Fastcase, PACER, and so forth, that may be accessed by the legal engine of the wireless earpieces 102. The wireless earpieces 102 may store any number of digital resources that may be updated regularly as noted above and which may include legislation, codes, statutes, constitutions, regulations, and so forth for the Federal Government, States, organizations, standards groups, and so forth.

The wireless earpieces 102 may determine their position with respect to each other as well as the wireless device 104 and the personal computer 118. For example, position information for the wireless earpieces 102 and the wireless device 104 may determine proximity of the devices in the communications environment 100. For example, global positioning information or signal strength/activity may be utilized to determine proximity and distance of the devices to each other in the communications environment 100. In one embodiment, the distance information may be utilized to determine whether biometric analysis may be displayed to a user. For example, the wireless earpieces 102 may be required to be within four feet of the wireless device 104 and the personal computer 118 in order to display biometric readings or receive user input. The transmission power or amplification of received signals may also be varied based on the proximity of the devices in the communications environment 100.

In one embodiment, the wireless earpieces 102 and the corresponding sensors 112 (whether internal or external) may be configured to take a number of measurements or log information and activities during normal usage. This information, data, values, and determinations may be reported to the user or otherwise utilized as part of the legal engine. The sensor measurements may be utilized to extrapolate other measurements, factors, or conditions applicable to the user 106 or the communications environment 100. For example, the sensors 112 may monitor the user's usage patterns or light sensed in the communications environment 100 to enter a full power mode in a timely manner. The user 106 or another party may configure the wireless earpieces 102 directly or through a connected device and app (e.g., mobile app with a graphical user interface) to set power settings (e.g., preferences, conditions, parameters, settings, factors, etc.) or to store or share biometric information, audio, and other data. In one embodiment, the user may establish the light conditions or motion that may activate the full power mode or that may keep the wireless earpieces 102 in a sleep or low power mode. As a result, the user 106 may configure the wireless earpieces 102 to maximize the battery life based on motion, lighting conditions, and other factors established for the user. For example, the user 106 may set the wireless earpieces 102 to enter a full power mode only if positioned within the ears of the user 106 within ten seconds of being moved, otherwise the wireless earpieces 102 remain in a low power mode to preserve battery life. This setting may be particularly useful if the wireless earpieces 102 are periodically moved or jostled without being inserted into the ears of the user 106. The wireless earpieces 102 may also be utilized to perform audio or light monitoring of a specified area.

The user 106 or another party may also utilize the wireless device 104 to associate user information and conditions with the user preferences. For example, an application executed by the wireless device 104 may be utilized to specify the conditions that may “wake up” the wireless earpieces 102 to automatically or manually communicate information, warnings, data, or status information to the user. In addition, the enabled functions (e.g., sensors, transceivers, vibration alerts, speakers, lights, etc.) may be selectively activated based on the user preferences as set by default, by the user, or based on historical information. In another embodiment, the wireless earpieces 102 may be adjusted or trained over time to become even more accurate in adjusting to legal needs, activities, habits, requirements, requests, activations, or other processes or functions performed by the legal engine. The wireless earpieces 102 may utilize historical information to generate default values, baselines, thresholds, policies, or settings for determining when and how the legal engine performs various communications, actions, and processes. As a result, the wireless earpieces 102 may effectively manage the automatic and manually performed processed of the wireless earpieces based on automatic detection of events and conditions (e.g., light, motion, user sensor readings, etc.) and user specified settings.

The wireless earpieces 102 may include any number of sensors 112 and logic for measuring and determining user biometrics, such as pulse rate, skin conduction, blood oxygenation, temperature, calories expended, blood or excretion chemistry, voice and audio output (e.g., stress level, amplitude, frequency, etc.), position, and orientation (e.g., body, head, etc.). The sensors 112 may also determine the user's location, position, velocity, impact levels, and so forth. Any of the sensors 112 may be utilized to detect or confirm light, motion, or other parameters that may affect how the wireless earpieces 102 manage, utilize, and initialize the legal engine. The sensors 112 may also receive user input and convert the user input into commands or selections made across the personal devices of the personal area network. For example, the user input detected by the wireless earpieces 102 may include voice commands, head motions, finger taps, finger swipes, motions or gestures, or other user inputs sensed by the wireless earpieces. The user input may be determined by the wireless earpieces 102 and converted into authorization commands that may be sent to one or more external devices, such as the wireless device 104, the personal computer 118, a tablet computer, or so forth. For example, the user 106 may create a specific head motion and voice command that when detected by the wireless earpieces 102 are utilized to send a request to the legal engine (implemented by the wireless earpiece or wireless earpieces 102/wireless device 104) to perform actions, such as provide legal definitions, record conversations or environmental noise, search precedent for a cited case, provide stress analysis of other user's voices, and so forth. Any number of actions may also be implemented by the legal engine in response to specified user input.

The sensors 112 may make all of the measurements with regard to the user 106 and communications environment 100 or may communicate with any number of other sensory devices, components, or systems in the communications environment 100. In one embodiment, the communications environment 100 may represent all or a portion of a personal area network. The wireless earpieces 102 may be utilized to control, communicate, manage, or interact with a number of other wearable devices or electronics, such as smart glasses, helmets, smart glass, watches or wrist bands, other wireless earpieces, chest straps, implants, displays, clothing, or so forth. The wireless earpieces 102 may also communicate with cameras, microphones, or other specialized or custom systems, equipment, components, software, or devices. A personal area network is a network for data transmissions among devices, components, equipment, and systems, such as personal computers, communications devices, cameras, vehicles, entertainment/media devices, and medical devices. The personal area network may utilize any number of wired, wireless, or hybrid configurations and may be stationary or dynamic. For example, the personal area network may utilize wireless network protocols or standards, such as INSTEON, IrDA, Wireless USB, Bluetooth, Z-Wave, ZigBee, Wi-Fi, ANT+ or other applicable radio frequency signals. In one embodiment, the personal area network may move with the user 106.

In other embodiments, the communications environment 100 may include any number of devices, components, or so forth that may communicate with each other directly or indirectly through a wireless (or wired) connection, signal, or link. The communications environment 100 may include one or more networks and network components and devices represented by the network 120, such as routers, servers, signal extenders, intelligent network devices, computing devices, or so forth. In one embodiment, the network 120 of the communications environment 100 represents a personal area network as previously disclosed. The legal engine herein described may also be utilized for any number of devices in the communications environment 100 with commands or communications being sent to and from the wireless earpieces 102, wireless device 104, personal computer 118 or other devices of the communications environment 100. Any of the devices in the communications environment 100 may include legal databases that may be accessed by the legal engine of the wireless earpieces 102 to perform the features, processes, method, and functionality as are herein described. The legal databases may be updated or replaced as needed.

Communications within the communications environment 100 may occur through the network 120 or a Wi-Fi network or may occur directly between devices, such as the wireless earpieces 102 and the wireless device 104. The network 120 may communicate with or include a wireless network, such as a Wi-Fi, cellular (e.g., 3G, 4G, 5G, PCS, GSM, etc.), Bluetooth, or other short range or long range radio frequency networks, signals, connections, or links. The network 120 may also include or communicate with any number of hard wired networks, such as local area networks, coaxial networks, fiber-optic networks, network adapters, or so forth. Communications within the communications environment 100 may be operated by one or more users, service providers, or network providers.

The wireless earpieces 102 may play, display, communicate, or utilize any number of alerts or communications to indicate that the actions, activities, communications, mode, or status are use or being implemented by the legal engine. For example, one or more alerts may indicate when legal engine actions automatically or manually selected by the user are in process, authorized, and/or changing with specific tones, verbal acknowledgements, tactile feedback, or other forms of communicated messages. For example, an audible alert and LED flash may be utilized each time the wireless earpieces 102 activate the legal engine to receive user input. Verbal or audio acknowledgements, answers, and actions utilized by the wireless earpieces 102 are particularly effective because of user familiarity with such devices in standard smart phone and personal computers. The corresponding alert may also be communicated to the user 106, the wireless device 104, and the personal computer 118. In one embodiment, alerts or indicators may be utilized to indicate that information or details are available to a user. For example, an audible alert, such as a beep, and a tactile alert, such as a single vibration, may indicate that the wireless earpieces have found legal analysis that may be presented audibly to the user if selected.

In other embodiments, the wireless earpieces 102 may also vibrate, flash, play a tone or other sound, or give other indications of the actions, status, or process of the legal engine. The wireless earpieces 102 may also communicate an alert to the wireless device 104 that shows up as a notification, message, or other indicator indicating changes in status, actions, commands, or so forth.

The wireless earpieces 102 as well as the wireless device 104 may include logic for automatically implementing the legal engine in response to motion, light, audio, user activities, user biometric status, user location, user orientation/position, historical activity/requests, or various other conditions and factors of the communications environment 100. The legal engine may be activated to perform a specified activity or to “listen” or be prepared to “receive” user input, feedback, or commands for implementation by the legal engine. The legal engine may also go into a recording or logging mode where all content or verbal communications are recorded for subsequent analysis, review, playback, or so forth.

The wireless device 104 may represent any number of wireless or wired electronic communications or computing devices, such as smart phones, laptops, desktop computers, control systems, tablets, transcription systems, security systems, displays, gaming devices, music players, personal digital assistants, vehicle systems, or so forth as well as the associated software (e.g., operating systems, kernels, applications, etc.). The wireless device 104 may communicate utilizing any number of wireless connections, standards, or protocols (e.g., near field communications, NFMI, Bluetooth, Wi-Fi, wireless Ethernet, etc.). For example, the wireless device 104 may be a touch screen cellular phone that communicates with the wireless earpieces 102 utilizing Bluetooth communications. The wireless device 104 may implement and utilize any number of operating systems, kernels, instructions, or applications that may make use of the available sensor data sent from the wireless earpieces 102. For example, the wireless device 104 may represent any number of android, iOS, Windows, open platforms, or other systems and devices. Similarly, the wireless device 104 or the wireless earpieces 102 may execute any number of applications that utilize the user input, proximity data, biometric data, and other feedback from the wireless earpieces 102 to initiate, authorize, or process legal engine processes and perform the associated tasks. In one embodiment, the wireless earpieces 102 and the wireless device 104 may both execute legal engines that may operate independently or jointly to perform the processes herein described utilizing one or more legal databases that are stored locally or accessed through the personal area network.

As noted, the layout of the internal components of the wireless earpieces 102 and the limited space available for a product of limited size may affect where the sensors 112 may be positioned. The positions of the sensors 112 within each of the wireless earpieces 102 may vary based on the model, version, and iteration of the wireless earpiece design and manufacturing process.

FIG. 2 is a block diagram of a wireless earpiece system 200 in accordance with an illustrative embodiment. As previously noted, the wireless earpieces 202 may be referred to or described herein as a pair (wireless earpieces) or singularly (wireless earpiece). The description may also refer to components and functionality of each of the wireless earpieces 202 collectively or individually. In one embodiment, the wireless earpiece system 200 may enhance communications and functionality of the wireless earpieces 202. In one embodiment, the wireless earpieces 202 may operate a legal engine independently. In another embodiment, the wireless earpieces 202 and a computing device 204 may implement a legal engine jointly or as separate instances that work together as part of the wireless earpiece system 200.

As shown, the wireless earpieces 202 may be wirelessly linked to the computing device 204. For example, the computing device 204 may represent a wireless tablet computer. The computing device 204 may also represent a transcription system, security system, gaming device, microphone/speaker array, cell phone, vehicle system (e.g., GPS, speedometer, pedometer, entertainment system, etc.), media device, smart watch, laptop, smart glass, or other electronic devices. User input and commands may be received from either the wireless earpieces 202 or the computing device 204 for implementation on either of the devices of the wireless earpiece system 200 (or other externally connected devices). In one embodiment, the wireless earpieces 202 and the computing device 204 may be utilized in a location 230. The location 230 may represent any number of locations, buildings, facilities, or environments. For example, the location 230 may represent a conference room as shown. In other embodiments, the location 230 may represent a court room, office, prison, client home, building, meeting, retail location, or so forth. Any number of activities may be performed at the location 230 including meetings, depositions, mediations, arbitration, contract negotiations, hearings, executive meetings, councils, interviews, trainings, classes, and so forth.

In some embodiments, the computing device 204 may act as a logging tool for receiving information, data, or measurements made by the wireless earpieces 202. For example, the computing device 204 may download data from the wireless earpieces 202 in real-time. As a result, the computing device 204 may be utilized to store, display, and synchronize data for the wireless earpieces 202. For example, the computing device 204 may store conversations, key words, conversation statistics, questions posed, designated information, and other information. In another example, the computing device 204 may display pulse, proximity, location, oxygenation, distance, calories burned, and so forth as measured by the wireless earpieces 202. The computing device 204 may be configured to receive and display an interface, selection elements, and alerts that indicate conditions to implement the legal engine. For example, the wireless earpieces 202 may utilize factors, such as keywords (e.g., lawsuit, indemnification, lawyer, attorney, judge, case, etc.), changes in motion or light, distance thresholds between the wireless earpieces 202 and/or computing device 204, signal activity, user orientation, user speed, user location, environmental factors (e.g., temperature, humidity, noise levels, proximity to other users, etc.) or other automatically determined or user specified measurements, factors, conditions, or parameters to implement various features, functions, and commands. The computing device 204 may also include a number of optical sensors, touch sensors, microphones, and other measurement devices that may provide feedback or measurements that the wireless earpieces 202 may utilize to determine an appropriate mode, settings, or enabled functionality to be utilized by the legal engine. The wireless earpieces 202 and the computing device 204 may have any number of electrical configurations, shapes, and colors and may include various circuitry, connections, and other components.

In one embodiment, the wireless earpieces 202 may include a battery 208, a logic engine 210, a memory 212, a user interface 214, a physical interface 215, a transceiver 216, sensors 217, a legal engine 218, and legal databases 220. The computing device 204 may have any number of configurations and include components and features similar to the wireless earpieces 202 as are known in the art. The legal engine 218 may be implemented as part of the logic engine 210, user interface, or other hardware, software, or firmware of the wireless earpieces and/or computing device 204. Similarly, the legal databases 220 may be stored by the legal engine 218 or in the memory 212. The computing device 204 may similarly store or access a number of legal databases.

The battery 208 is a power storage device configured to power the wireless earpieces 202. In other embodiments, the battery 208 may represent a fuel cell, thermal electric generator, piezo electric charger, solar charger, ultra-capacitor, or other existing or developing power storage technologies. The logic engine 210 preserves the capacity of the battery 208 by reducing unnecessary utilization of the wireless earpieces 202 in a full-power mode when there is little or no benefit to the user (e.g., the wireless earpieces 202 are sitting on a table or temporarily lost). In one embodiment, the battery 208 or power of the wireless earpieces are preserved for when being worn or operated by the user. As a result, user satisfaction with the wireless earpieces 202 is improved and the user may be able to set the wireless earpieces 202 aside at any moment knowing that battery life is automatically preserved by the logic engine 210 and functionality of the wireless earpieces 202. In another embodiment, the logic engine 210 may receive user input from the user through the user interface 214 to operate even when the wireless earpieces 202 are not worn by a user (e.g., charging in the smart case, set upon a table, etc.). For example, the wireless earpieces 202 may be utilized to record and transcribe discussions between an attorney and client to send a client an outline of the discussion and relevant notes.

The logic engine 210 is the logic that controls the operation and functionality of the wireless earpieces 202. The logic engine 210 may include circuitry, chips, and other digital logic. The logic engine 210 may also include programs, scripts, and instructions that may be implemented to operate the logic engine 210. The logic engine 210 may represent hardware, software, firmware, or any combination thereof. In one embodiment, the logic engine 210 may include one or more processors. The logic engine 210 may also represent an application specific integrated circuit (ASIC) or field programmable gate array (FPGA). In one embodiment, the logic engine 210 may execute instructions to manage the legal engine 218 including interactions with the components of the wireless earpieces 202, such as the user interface 214 and sensors 217.

The logic engine 210 may utilize measurements from two or more of the sensors 217 to determine whether the legal engine 218 is being requested or is otherwise needed. The logic engine 210 may control actions implemented the legal engine 218 in response to any number of measurements from the sensors 217, the transceiver 216, the user interface 214, or the physical interface 215 as well as user preferences 222 that may be user entered or default preferences. For example, the logic engine 210 may initialize or otherwise use the legal engine 218 in response to any number of factors, conditions, parameters, measurements, data, values, or other information specified within the logic engine 210 or by the user preferences 222. For example, the user preferences 222 may specify that in response to one or more internal or external microphones detecting a keyword (e.g., client name, legal term, passcode, etc.) the legal engine may be activated to perform any number of actions or activities.

The logic engine 210 may also determine whether the wireless earpieces 202 are actively performing any user-requested functions that may require that activation of the legal engine 218 or that the legal engine 218 be ready to receive a request. For example, the logic engine may determine whether music is being played, communications being received, processed, or sent, noise-cancellation is being performed and so forth. Utilizing the user preferences, the logic engine 210 may execute instructions to initiate and implement the legal engine 218. If user input, feedback, or communications are detected or received, the logic engine 210 may initiate the legal engine 218 to perform a task associated with the input. For example, the legal engine 218 may implement wireless earpieces 202 to answer questions, provide user biometrics, answer activity related questions (e.g., when is my next hearing, how many times did I say mediation during my last conversation, what address and floor is my meeting at, etc.) manage features, functions, or components, answer general questions, and so forth. The wireless earpieces 202 may be configured to work together or completely independently based on the needs of the user. For example, the wireless earpieces 202 may be used by two different users at one time to perform the illustrative embodiments.

The logic engine 210 may also process user input to determine commands implemented by the wireless earpieces 202 or sent to the computing device 204 through the transceiver 216. Specific actions may be associated with user input (e.g., voice, tactile, orientation, motion, gesture, etc.). For example, the logic engine 210 may implement a macro allowing the user to associate frequently performed actions with specific commands/input implemented by the legal engine 218. For example, in response to a user nodding her head two times, the wireless earpieces may automatically record audible content for 30 minutes (the same signal may be utilized to end the recording). In another example, the wireless earpieces may be tapped twice so that the next spoken term may be retrieved from legal dictionaries. In another example, the user may speak commands, such as “Case Updates for KSR” to get the most recent legal precedent relevant to an applicable case (e.g., Shepardize by LexisNexis®). The abstract or a summary of the retrieved legal updates may be played audibly through the wireless earpieces 202 or communicated to the computing device 204. In another example, a user may swipe up against the external surface of the wireless earpieces to activate a transcription process of the wireless earpieces 202 or the computing device 204 with the wireless earpieces receiving the verbal communications from the user.

In one embodiment, a processor included in the logic engine 210 is circuitry or logic enabled to control execution of a set of instructions. The processor may be one or more microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks.

The memory 212 is a hardware element, device, or recording media configured to store data or instructions for subsequent retrieval or access at a later time. The memory 212 may represent static or dynamic memory. The memory 212 may include a hard disk, random access memory, cache, removable media drive, mass storage, or configuration suitable as storage for data, instructions, and information. In one embodiment, the memory 212 and the logic engine 210 may be integrated. The memory may use any type of volatile or non-volatile storage techniques and mediums. The memory 212 may store information related to the status of a user, wireless earpieces 202, computing device 204, and other peripherals, such as a wireless device, smart glasses, a smart watch, a smart case for the wireless earpieces 202, a wearable device, and so forth. In one embodiment, the memory 212 may display instructions, programs, drivers, or an operating system for controlling the user interface 214 including one or more LEDs or other light emitting components, speakers, tactile generators (e.g., vibrator), and so forth. The memory 212 may also store thresholds, conditions, signal or processing activity, proximity data, and so forth.

The transceiver 216 is a component comprising both a transmitter and receiver which may be combined and share common circuitry on a single housing. The transceiver 216 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.), infrared, or other suitable radio frequency standards, networks, protocols, or communications. The transceiver 216 may also be a hybrid or multi-mode transceiver that supports a number of different communications. For example, the transceiver 216 may communicate with the computing device 204 or other systems utilizing wired interfaces (e.g., wires, traces, etc.), NFC, or Bluetooth communications as well as with the other wireless earpiece utilizing NFMI. The transceiver 216 may also detect amplitudes and signal strength to infer distance between the wireless earpieces 202 themselves as well as the computing device 204.

The components of the wireless earpieces 202 may be electrically connected utilizing any number of wires, contact points, leads, busses, wireless interfaces, or so forth. In addition, the wireless earpieces 202 may include any number of computing and communications components, devices or elements which may include busses, motherboards, printed circuit boards, circuits, chips, sensors, ports, interfaces, cards, converters, adapters, connections, transceivers, displays, antennas, and other similar components. The physical interface 215 is hardware interface of the wireless earpieces 202 for connecting and communicating with the computing device 204 or other electrical components, devices, or systems.

The physical interface 215 may include any number of pins, arms, or connectors for electrically interfacing with the contacts or other interface components of external devices or other charging or synchronization devices. For example, the physical interface 215 may be a micro USB port. In one embodiment, the physical interface 215 is a magnetic interface that automatically couples to contacts or an interface of the computing device 204. In another embodiment, the physical interface 215 may include a wireless inductor for charging the wireless earpieces 202 without a physical connection to a charging device. The physical interface 215 may allow the wireless earpieces 202 to be utilized when not worn as a remote microphone and sensor system (e.g., seismometer, thermometer, light detection unit, motion detector, audio recorder, etc.). For example, measurements, such as noise levels, temperature, movement, and so forth may be detected by the wireless earpieces even when not worn. In another example, the wireless earpieces 202 may be utilized as a temporary security system recording motion and audio detected in an associated location. The wireless earpieces 202 may be utilized as a pair, independently, or even when stored in a smart case. Each of the wireless earpieces 202 may provide distinct sensor measurements as needed.

The user interface 214 is a hardware interface for receiving commands, instructions, or input through the touch (haptics) of the user, voice commands, or predefined motions. The user interface 214 may further include any number of software and firmware components for interfacing with the user. In one embodiment, the legal engine 218 may be integrated with the user interface 214. The user interface 214 may be utilized to manage and otherwise control the other functions of the wireless earpieces 202. The user interface 214 may include the LED array, one or more touch sensitive buttons or portions, a miniature screen or display, or other input/output components (e.g., the user interface 214 may interact with the sensors 217 extensively). The user interface 214 may be controlled by the user or based on commands received from the computing device 204 or a linked wireless device. For example, the user may turn on, reactivate, or provide feedback for the legal engine 218 or other features, functions, and components of the wireless earpieces 202 utilizing the user interface 214.

In one embodiment, the user may provide user input for the legal engine 218 by tapping the user interface 214 once, twice, three times, or any number of times. Similarly, a swiping motion may be utilized across or in front of the user interface 214 (e.g., the exterior surface of the wireless earpieces 202) to implement a predefined action. Swiping motions in any number of directions or gestures may be associated with specific legal engine 218 controlled activities or actions, such as activate the legal engine 218, listen for commands, record audio, retrieve definitions, find hearing calendar items, enable dictation and transcription, schedule meetings, retrieve a statute, regulation, or case law, measure voice stress of participants in a conversation, and so forth. The user interface 214 may utilize the legal databases to retrieve applicable information, systems, data, and applications.

The swiping motions may also be utilized to control actions and functionality of the computing device 204 or other external devices (e.g., smart television, camera array, smart watch, etc.). The user may also provide user input by moving his head in a particular direction or motion or based on the user's position or location. For example, the user may utilize voice commands, head gestures, or touch commands to change the processes implemented by the legal engine 218 as well as the content displayed by the computing device 204. The user interface 214 may also provide a software interface including any number of icons, soft buttons, windows, links, graphical display elements, and so forth.

In one embodiment, the sensors 217 may be integrated with the user interface 214 to detect or measure the user input. For example, infrared sensors positioned against an outer surface of the wireless earpieces 202 may detect touches, gestures, or other input as part of a touch or gesture sensitive portion of the user interface 214. The outer or exterior surface of the user interface 214 may correspond to a portion of the wireless earpieces 202 accessible to the user when the wireless earpieces are worn within the ears of the user.

In addition, the sensors 217 may include pulse oximeters, accelerometers, thermometers, barometers, radiation detectors, gyroscopes, magnetometers, global positioning systems, beacon detectors, inertial sensors, photo detectors, miniature cameras, and other similar instruments for detecting user biometrics, environmental conditions, location, utilization, orientation, motion, and so forth. The sensors 217 may provide measurements or data that may be utilized to select, activate, or otherwise utilize the legal engine 218. Likewise, the sensors 217 may be utilized to awake, activate, initiate, or otherwise implement actions and processes utilizing conditions, parameters, values, or other data within the user preferences 222. For example, the optical biosensors within the sensors 217 may determine whether the wireless earpieces 202 are being worn and when a selected gesture activating the legal engine 218 to look up facts associated with another user's verbal output is provided by the user. For example, facts regarding a lawsuit or previous admissions by a witness may be compared against previous data in real-time to provide warnings, alerts, or indicators if there are any discrepancies or potential issues.

The computing device 204 may include components similar in structure and functionality to those shown for the wireless earpieces 202. The computing device may include any number of processors, batteries, memories, busses, motherboards, chips, transceivers, peripherals, sensors, displays, cards, ports, adapters, interconnects, and so forth. In one embodiment, the computing device 204 may include one or more processors and memories for storing instructions. The instructions may be executed as part of an operating system, application, browser, or so forth to implement the features herein described. For example, docketing, accounting, case tracking, human resource, document management, email, calendaring, education, or other software and applications may be executed by the computing device 204 and/or the wireless earpieces 202.

In one embodiment, the wireless earpieces 202 may be magnetically or physically coupled to the computing device 204 to be recharged or synchronized or to be stored. In one embodiment, the computing device 204 may include a virtual assistant or legal engine that is compatible with the legal engine 218. As a result, the separate instances may function as a single legal engine, legal assistant, or virtual assistant to enhance functionality. In addition, the seamless integration may appear to the user as a single legal engine (even though multiple instances may be involved across a number of different wireless and wired electronic devices). In another embodiment, the wireless earpieces 202 and computing device 204 may still communicate effectively to perform the methods and processes herein described even if the legal engine for the computing device 204 is different from the legal engine 218. For example, distinct legal engines may still communicate and interact based on developing interfaces, protocols, or standards from different service providers, manufacturers, and developers. For example, the wireless earpieces 202 or the computing device 204 may utilize data mashup or access technologies to interface with 3^{rd} party web services, such as Google, Microsoft, Facebook, Yelp, Twitter, LexisNexis, Westlaw, Reuters, and others to perform actions, search requests, look up information, question answering, and other relevant services. The computing device 204 may include or access local or network available legal databases, services, or systems. The legal engine 218 may also transform output from 3^{rd} party web services back into natural language (e.g., you are ineligible to serve on this jury because of your two previous felony convictions”, or based on the traffic report “you need to leave for your hearing right now to be on time.”) The legal engine 218 of the wireless earpieces 204 or of the computing device 204 may also utilize text-to-speech (TTS) technologies or logic to transform natural language or to parse text, information, values, or data as is herein described. The legal engine 218 may also perform language translation in real-time eliminating the need for a translator for simple or routine conversations. The language or speech detected by one or more microphones of the wireless earpieces 202 may be converted into the natural language of the user of the wireless earpieces 202.

The computing device 204 may also execute a legal engine (not shown) that may utilize information, data, and resources from the wireless earpieces 202 and legal engine 218 to implement user requested actions. The computing device 204 may be utilized to adjust the user preferences 222 including settings, thresholds, activities, conditions, environmental factors, and so forth utilized by the legal engines of both the wireless earpieces 202 and the computing device 204. For example, the computing device 204 may utilize a graphical user interface available through a mobile application that allows the user to more easily specify any number of conditions, values, measurements, parameters, and factors that are utilized as part of the user preferences 222 to control or manage the legal engine 218.

In another embodiment, the computing device 204 may also include sensors for detecting the location, orientation, and proximity of the wireless earpieces 202 to the computing device 204. The wireless earpieces 202 may turn off communications to the computing device 204 in response to losing a status or heart beat connection to preserve battery life and may only periodically search for a connection, link, or signal to the computing device 204. The wireless earpieces 202 may also turn off components, enter a low power or sleep mode, or otherwise preserve battery life in response to not detecting interaction from the user for a time period, not detecting the presence of the user (e.g., touch, light, conductivity, motion, etc.), or so forth.

As originally packaged, the wireless earpieces 202 and the computing device 204 may include peripheral devices such as charging cords, power adapters, inductive charging adapters, solar cells, batteries, lanyards, additional light arrays, speakers, smart case covers, transceivers (e.g., Wi-Fi, cellular, etc.), or so forth. In one embodiment, the wireless earpieces 202 may include a smart case (not shown). The smart case may include an interface for charging the wireless earpieces 202 from an internal battery as well as through a plugged connection. The smart case may also utilize the interface or a wireless transceiver to log utilization, audio, motion activity, biometric information of the user, and other information and data. For example, the smart case may include a non-volatile memory for storing, archiving, synchronizing, or updating information, data, legal databases 220, user preferences 222, or other applicable information.

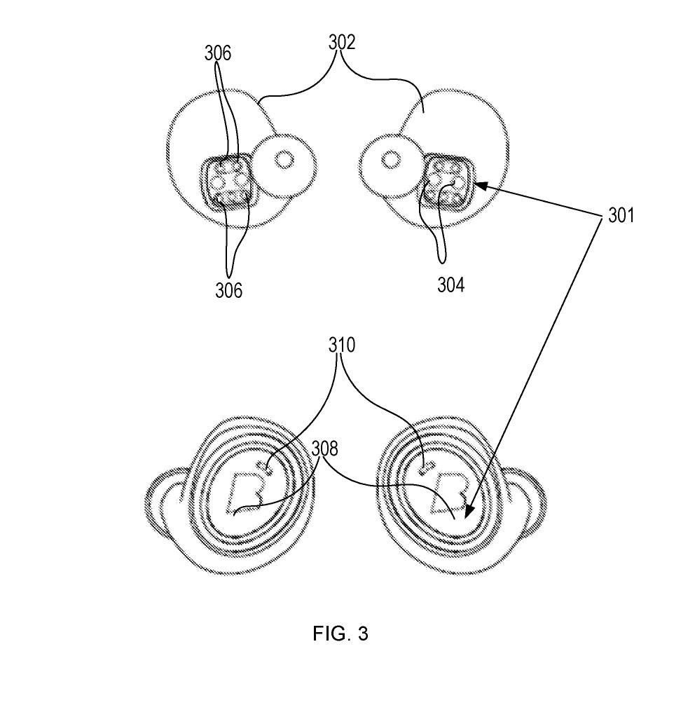

FIG. 3 is a pictorial representation of some of the sensors 301 of the wireless earpieces 302 in accordance with illustrative embodiments. As previously noted, the wireless earpieces 302 may include any number of internal or external sensors. In one embodiment, the sensors 301 may be utilized to determine whether the legal assistant is activated, utilized, or listening for user input. Similarly, any number of other components or features of the wireless earpieces 302 may be managed based on the measurements made by the sensors 301 to preserve resources (e.g., battery life, processing power, etc.).

The sensors 301 may make independent measurements or combined measurements utilizing the sensory functionality of each of the sensors 301 to measure, confirm, or verify sensor measurements.

In one embodiment, the sensors 301 may include optical sensors 304, contact sensors 306, infrared sensors 308, and microphones 310. The optical sensors 304 may generate an optical signal that is communicated to the ear (or other body part) of the user and reflected back. The reflected optical signal may be analyzed to determine blood pressure, pulse rate, pulse oximetry, vibrations, blood chemistry, and other information about the user. The optical sensors 304 may include any number of sources for outputting various wavelengths of electromagnetic radiation and visible light. Thus, the wireless earpieces 302 may utilize spectroscopy as it is known in the art and developing to determine any number of user biometrics.

The optical sensors 304 may also be configured to detect ambient light proximate the wireless earpieces 302. For example, the optical sensors 304 may detect light and light changes in an environment of the wireless earpieces 302, such as in a room where the wireless earpieces 302 are located. The optical sensors 304 may be configured to detect any number of wavelengths including visible light that may be relevant to light changes, approaching users or devices, and so forth.

In another embodiment, the contact sensors 306 may be utilized to determine that the wireless earpieces 302 are positioned within the ears of the user. For example, conductivity of skin or tissue within the user's ear may be utilized to determine that the wireless earpieces are being worn. In other embodiments, the contact sensors 306 may include pressure switches, toggles, or other mechanical detection components for determining that the wireless earpieces 302 are being worn. The contact sensors 306 may measure or provide additional data points and analysis that may indicate the biometric information of the user. The contact sensors 306 may also be utilized to apply electrical, vibrational, motion, or other input, impulses, or signals to the skin of the user.

The wireless earpieces 302 may also include infrared sensors 308. The infrared sensors 308 may be utilized to detect touch, contact, gestures, or other user input. The infrared sensors 308 may detect infrared wavelengths and signals. In another embodiment, the infrared sensors 308 may detect visible light or other wavelengths as well. The infrared sensors 308 may be configured to detect light or motion or changes in light or motion. Readings from the infrared sensors 308 and the optical sensors 304 may be configured to detect light or motion. The readings may be compared to verify or otherwise confirm light or motion. As a result, virtual assistant decisions regarding user input, biometric readings, environmental feedback, and other measurements may be effectively implemented in accordance with readings form the sensors 301 as well as other internal or external sensors and the user preferences. The infrared sensors 308 may also include touch sensors integrated with or proximate the infrared sensors 308 externally available to the user when the wireless earpieces 302 are worn by the user.

The wireless earpieces 310 may include microphones 310. The microphones 310 may represent external microphones as well as internal microphones. The external microphones may be positioned exterior to the body of the user as worn. The external microphones may sense verbal or audio input, feedback, and commands received from the user. The external microphones may also sense environmental, activity, additional users (e.g., clients, jury members, judges, attorneys, paralegals, etc.), and external noises and sounds. The internal microphone may represent an ear-bone or bone conduction microphone. The internal microphone may sense vibrations, waves, or sound communicated through the bones and tissue of the user's body (e.g., skull). The microphones 310 may sense content that is utilized by the legal engine of the wireless earpieces 302 to implement the processes, functions, and methods herein described. The audio input sensed by the microphones 310 may be filtered, amplified, or otherwise processed before or after being sent to the processor/logic of the wireless earpieces 302.

In another embodiment, the wireless earpieces 302 may include chemical sensors (not shown) that perform chemical analysis of the user's skin, excretions, blood, or any number of internal or external tissues or samples. For example, the chemical sensors may determine whether the wireless earpieces 302 are being worn by the user. The chemical sensor may also be utilized to monitor important biometrics that may be more effectively read utilizing chemical samples (e.g., sweat, blood, excretions, etc.). In one embodiment, the chemical sensors are non-invasive and may only perform chemical measurements and analysis based on the externally measured and detected factors. In other embodiments, one or more probes, vacuums, capillary action components, needles, or other micro-sampling components may be utilized. Minute amounts of blood or fluid may be analyzed to perform chemical analysis that may be reported to the user and others. The sensors 301 may include parts or components that may be periodically replaced or repaired to ensure accurate measurements. In one embodiment, the infrared sensors 308 may be a first sensor array and the optical sensors 304 may be a second sensor array.

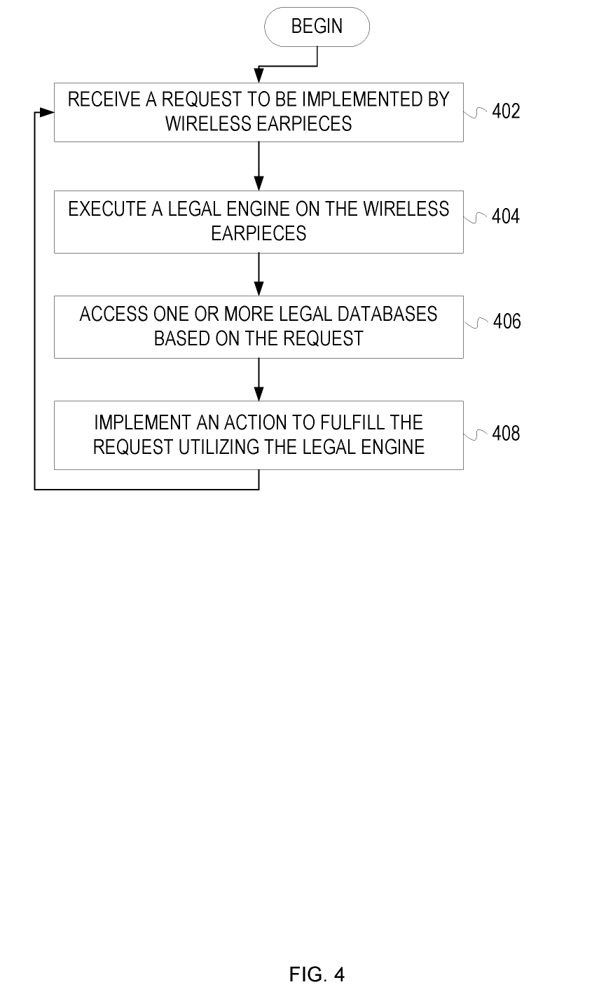

FIG. 4 is a flowchart of a process for utilizing a legal engine for wireless earpieces in accordance with an illustrative embodiment. The process of FIG. 4 may be implemented by one or more wireless earpieces, such as the wireless earpieces 102 of FIG. 1. The process of FIG. 4 may be implemented by a legal engine of the wireless earpieces. The legal engine may operate independently from the legal engines or virtual assistants of other wireless or computing devices. In an alternative embodiment, one or more steps or portions of the process of FIG. 4 may be implemented by a wireless device, computing device, wearable devices, or any number of other devices communicating directly or through a network with the wireless earpieces. The processes and steps of FIGS. 4-7 may be combined as well as performed in any order.

In one embodiment, the process may begin with the wireless earpieces receiving a request to be implemented by wireless earpieces (step 402). The request may represent a command, input, feedback, or measurements indicating that instructions, commands, or input are forthcoming to the legal engine. For example, the request may be a legal request that specifies that a reporting command for the legal engine of the wireless earpieces is immediately or subsequently forthcoming. The request may also put the legal engine in a “listen” mode. In another embodiment, the request may represent the actual instructions, commands, or input the user is communicating for implementation by the legal engine of the wireless earpieces. For example, the user may ask, “what is the legal phrase for preliminary review or jury members as part of jury selection?” (to which the wireless earpieces may subsequently respond in the described process as “voir dire”).

The request may be received in any number of ways associated with the components of the wireless earpieces. In one embodiment, the request may be a verbal request, such as “when is my next hearing for the Alice case”, or “how many patent litigation cases were filed last year in the Eastern District of Texas?”, or “please translate ‘your contract needs to be rewritten’ from English into Spanish.” In another embodiment, the request may be a tactile request, such as a tap, swipe, or other input detected by the wireless earpieces. In another embodiment, the request may be a gesture detected by the wireless earpieces, such as a hand motion or shape made proximate the wireless earpieces, a head nod, or so forth. In another embodiment, the request may be a position, location, or orientation of the user. For example, in response to determining the user is sitting and leaned forward, the legal engine of the wireless earpieces may be configured to audibly play questions previously specified by the user for questioning a witness.

Next, the wireless earpieces execute a legal engine (step 404). In one embodiment, the legal engine may be activated as requested by the user. For example, the request may be converted into a command succeeded by the logic or processor of the wireless earpieces to activate the legal engine. In other embodiments, the legal engine may always run as a background program. The legal engine may also be activated based on user preferences (as is subsequently described). The legal engine may represent hardware logic (e.g., transistors, gates, digital logic, ASIC, FPGA, etc.) or an application, operating system, kernel, instructions, or other forms of software (or a combination of hardware and software).

Next, the wireless earpieces access one or more legal databases based on the request (step 406). In one embodiment, the legal databases may be stored locally on the wireless earpieces. In another embodiment, the legal databases may be accessed through one or more computing or wireless devices in communication with the wireless earpieces. The request may include additional user input or information that is utilized to access the legal databases or services (e.g., LexisNexis, Westlaw, BNA, American Lawyer, Blomberg Law, Legal Reporters, Fastcase, PACER, etc.). For example, once the request is received the user may further specify that the user wants to retrieve specific information or perform another specific action.

Next, the wireless earpieces implement an action to fulfill the request utilizing the legal engine of the wireless earpieces (step 408). The legal engine may implement any number of commands, input, or feedback. In one embodiment, the legal engine may implement the actions without requiring a connection to one or more networks, communications connections, signals, or other devices. The autonomous operation of the legal engine of the wireless earpieces may be particularly useful when the user is without a network or device connection, actively engaged in a hearing, meeting (e.g., client interview, mediation, arbitration, conference, etc.), other activity, or so forth. The legal engine may provide regulation, statutes, ethical, factual, news reports, biometric, environmental, and other data and information to the user. The legal engine may also initiate, open, close, control, or execute any number of applications, logic, components, features, and functions of the wireless earpieces. For example, a dictation application specific to dictation and transcription may be opened in response to the user saying open “I am dictating.”

In another embodiment, the legal engine may open a research application by nodding her head twice before saying “find legal precedent in Kentucky for determining a will was executed under duress.” The legal engine retrieves the applicable information from the legal databases or memory, logic, sensors, or other components of the wireless earpieces to immediately provide the answer to the user (or otherwise indicate that the information is not currently available). In additional embodiments, the wireless earpieces may have databases, logic, or additional sensors that allow the wireless earpieces to independently answer legal questions, biometric or location requests, indicate proximity to users and locations, and general knowledge questions (e.g., the types of answers that existing smart assistants provide”. In one embodiment, the user may specify types of databases or information available through the legal engine. In one embodiment, the action of step 406 may implement a process that requires additional feedback, steps, or so forth.

Although not specifically shown, the wireless earpieces may be linked with communications devices. The wireless earpieces may be linked with the communications device, such as a smart phone, utilizing any number of communications, standards, or protocols. For example, the wireless earpieces may be linked with a cell phone by a

Bluetooth connection. The process may require that the devices be paired utilizing an identifier, such as a passcode, password, serial number, voice identifier, radio frequency, or so forth. The wireless earpieces may be linked with the communications device and any number of other devices directly or through one or more networks, such as a personal area network. The wireless earpieces may be linked so that actions or commands implemented by the wireless earpieces may also implemented or communicated across one or more wireless device(s) (e.g., for reporting, synchronization, process management, etc.). In addition, any number of alerts, messages, or indicators may be sent between the two devices to present information to the user. In another embodiment, the pairs of wireless earpieces may be linked with other pairs of wireless earpieces.

The information utilized by the wireless earpieces may come from any number of databases (legal or otherwise), sensor components, arrays, memories, or other wireless earpiece resources. Any number of optical, infrared, touch, motion, orientation, and location sensors may be utilized whether internally or externally positioned (e.g., when the wireless earpieces are worn by the user). The sensor measurements may be processed or otherwise evaluated by the wireless earpieces for implementing various processes. For example, one or more processors of the wireless earpieces may process the incoming data measurements from first and second sensor arrays so that legal questions or requests may be quickly answered or retrieved. For example, in response to the wireless earpieces detecting the user of the wireless earpieces or an additional user asking “when was the agreement executed”, the wireless earpieces may retrieve the information from available facts to respond “the agreement was executed by both parties on Jun. 21, 2019.” The wireless earpieces may utilize predictive logic to determine the most common requests received by the wireless earpieces so that the applicable data, measurements, or processing are already completed or ready to be completed without delay based on a request received by the legal engine. Additional, optical, chemical, mechanical, and/or electrical sensors of the wireless earpieces or a connected wireless device may also be utilized. The sensor measurements are processed for subsequent analysis, determinations, or decisions, implemented by the wireless earpieces.

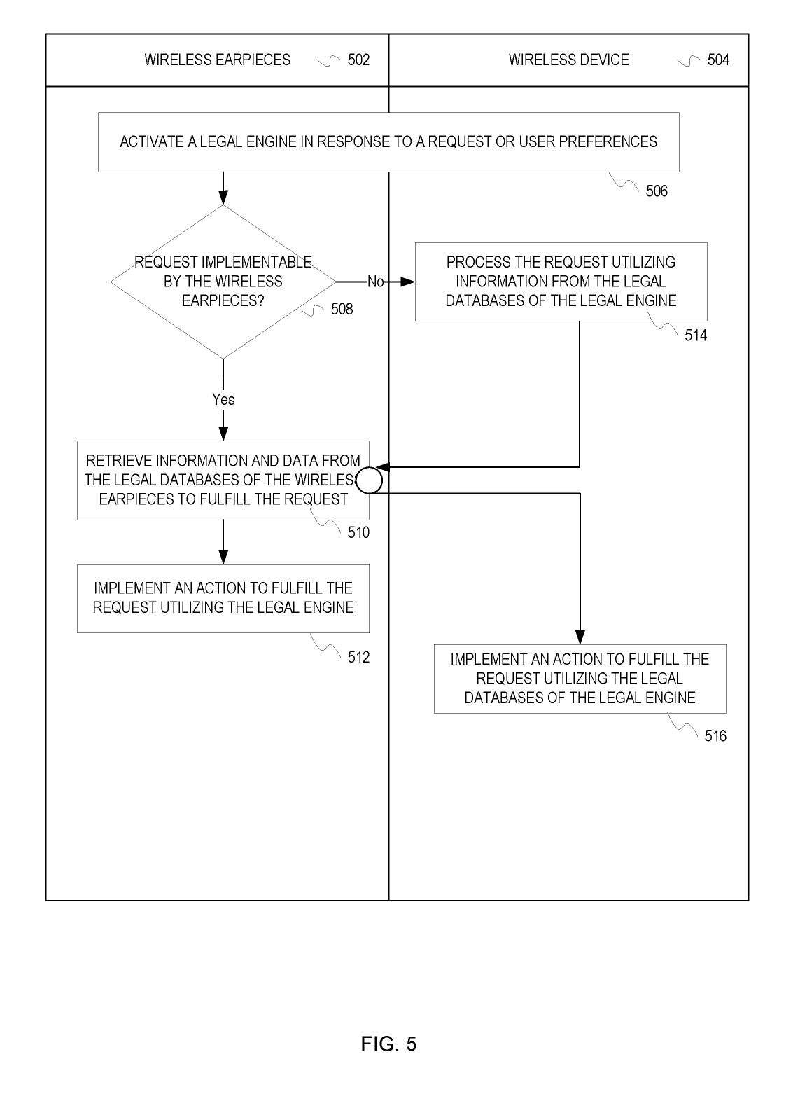

FIG. 5 is a flowchart of a process for utilizing a legal engine for wireless earpieces and a wireless device in accordance with an illustrative embodiment. In one embodiment, the process of FIG. 5 may be implemented by wireless earpieces 502 in communication with the wireless device 504 (jointly the “system”). The wireless earpieces 502 and wireless device 504 may represent devices, such as those shown in FIGS. 1-3. The method of FIG. 5 also be performed independently by either the left wireless earpiece or the right wireless earpiece.

The process may begin with the wireless earpieces 502 or the wireless device 504 activating a legal engine (step 506). The legal engine may be automatically or manually activated based on a request from the user, user preferences, location, activity, date, time-of-day, application commands, or any number of other factors, conditions, parameters, feedback, or so forth. For example, the legal engine may be activated in response to determining the user is in his office, at a court house, or in a scheduled meeting. As noted, the wireless earpieces 502 and the wireless device 504 may individually or collectively implement or execute a legal engine. The legal engine may represent a single instance executed across both devices, common or similar legal engines, or distinct legal engines. In one embodiment, the legal engine is activated in response to the wireless earpieces 502 and/or the wireless device 504 being powered on or in response to a legal engine based application being opened. The request may be to activate the legal engine or may specify a question, process, or action the legal engine is activated to address. As a result, the wireless earpieces 502 may request additional input, feedback, or information to fulfill the request. Any number of audible, tactile, or text-based requests may be made through the wireless earpieces 502 or the wireless device 504.

Next, the wireless earpieces 502 determine whether the request received by the legal engine is implementable by the wireless earpieces 502 (step 508). The wireless earpieces 502 determine whether the request is implementable based on the information, applications, processes, and methodologies available to the wireless earpieces 502. In one embodiment, the request may be received audibly from the user. In other embodiments, the request may be automatically or manually received alphanumerically, tactilely, based on historical requests, based on user preferences, or so forth. Reception of the request may be received as part of step 506 or may alternatively represent a different step altogether. In one embodiment, the determination of whether the request is implementable by the wireless earpieces 502 may be conditional based on information or data available through one or more legal databases or services that may be stored locally on the wireless earpieces 502. In other embodiments, the databases or services may be accessed by the wireless earpieces, but are not implementable by the wireless earpieces (as a stand-alone implementation or action).

In response to determining the request is implementable by the wireless earpieces 502 during step 508, the wireless earpieces 502 retrieve information and data from the legal databases to fulfill the request (step 510). In one embodiment, the legal engine of the wireless earpieces 502 may retrieve the information from the databases, services, or applications available independently on the wireless earpieces 502. The resources (e.g., databases, services, etc.) available through the wireless earpieces 502 may also include 3^{rd}-party applications, databases, logic, processes, or information that may be automatically or manually (user selected) uploaded for access by users that wear the wireless earpieces 502. In one embodiment, the wireless earpieces 502 may request additional information, clarification, or input in order to fulfill the request.

Next, the wireless earpieces 502 implement an action to fulfill the request utilizing the legal engine (step 512). As noted, the action may be performed by the legal engine or other components, modules, functions, or other portions of the wireless earpieces 502. As needed, the sensors of the wireless earpieces 502 may be utilized to provide biometric, user, and environmental measurements applicable to the request. In one embodiment, the legal engine may provide definitions, statutes, laws, regulations, case law, or other legal information based on a request that may include “Define . . . ”, “What is the federal law applicable to elder abuse”, “What has the Supreme Court said about _____ . . . ”, “What policies does the FAA have in place for drone pilots that are not registered . . . ”, “What does the New York Court of Appeals define as fraud based on current case law . . . ”, and so forth.

In response to determining the request is not implementable (e.g., partially, entirely, etc.) by the wireless earpieces 502 during step 510, the wireless device 504 processes the request utilizing information from the legal databases of the legal engine (step 514). In one embodiment, some requests made by the user may require processing power, information, connections, signals, and networks, or other resources that may be beyond those available to the wireless earpieces 502 alone. As a result, the request may be implemented in part by the wireless device 504 with or without additional communications with the wireless earpieces 502.

Next, the wireless device 504 retrieves information and data from the wireless earpieces to fulfill the request (step 510). In one embodiment, the wireless device 504 may send a request for applicable information to the wireless earpieces 502. For example, the wireless device 504 may request user input (e.g., verbal, tactile, or gesture based requests, etc.) or user biometrics that may be communicated from the wireless earpieces 502 to the wireless device at least in part to respond to the request. If information is not required from the wireless earpieces 502, the wireless device 504 may process the request without retrieving information as is described in step 510. For example, user input and biometric data may be periodically communicated or synchronized between the wireless earpieces 502 and the wireless device 504, and, as a result, the wireless device 504 may not require additional information or communications with the wireless earpieces 502.

Next, the wireless device 504 implements an action to fulfill the request utilizing the legal databases of the legal engine (step 516). The wireless device 504 may utilize any number of locally available databases and/or services or externally available databases and/or services to perform the action to fulfill the request.

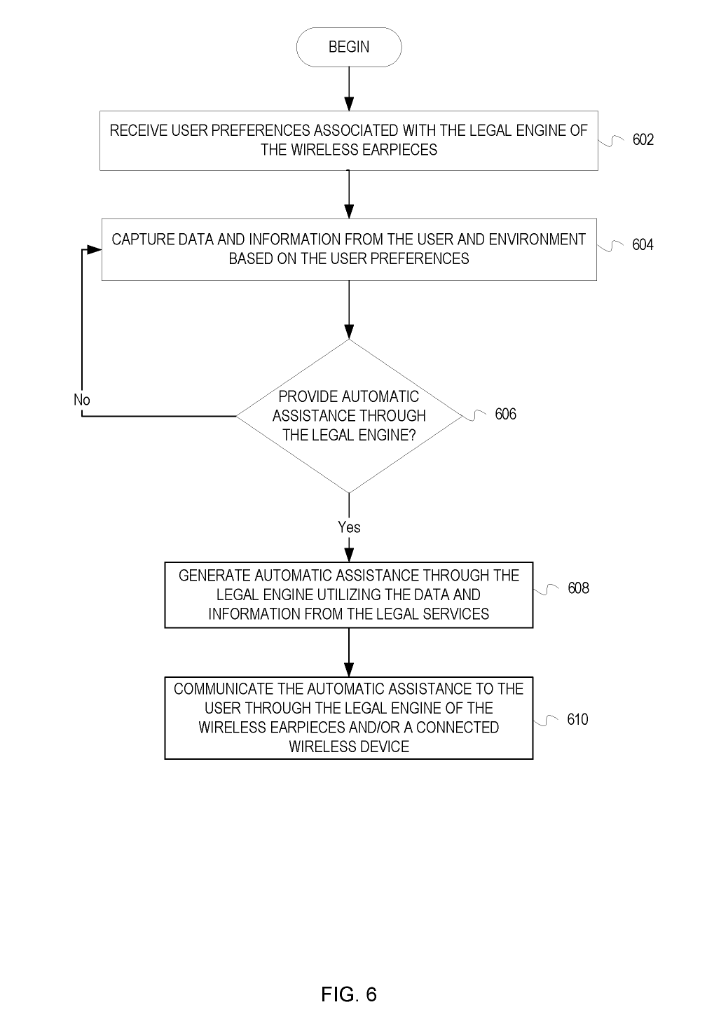

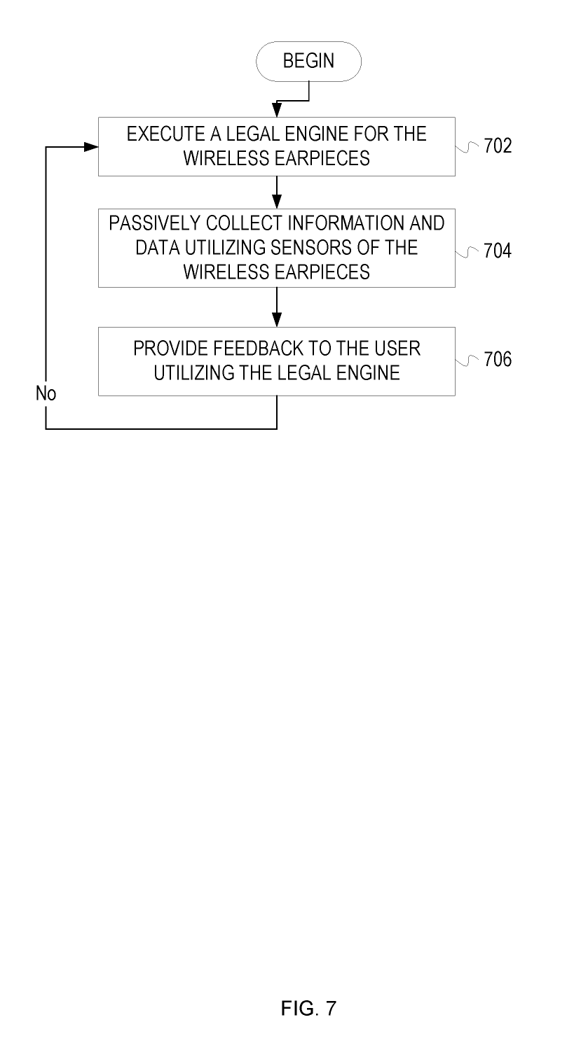

FIG. 6 is a flowchart of a process for automatically implementing a legal engine in accordance with an illustrative embodiment. In one embodiment, the process of FIGS. 6 and 7 may be implemented by wireless earpieces, individually, or as a set. The wireless earpieces may be utilized as stand-alone devices or may communicate with one or more devices (e.g., a smart phone) through a connection, signal, or network.

The process may begin by receiving user preferences associated with the wireless earpieces (step 602). In one embodiment, the user preferences may be provided directly through the wireless earpieces. For example, an interactive audio menu may audibly present a number of options to a user in order to receive various selections or feedback. The information may be presented by one or more speakers and user input may be received through one or more microphones of the wireless earpieces. The user may also provide the user preferences utilizing free form text, such as “record all content when I am in the deposition room at 123 LegalEagle Street” or “automatically determine if cases are up-to-date when ask for updates to a specified case.” In another embodiment, the user preferences may be selected utilizing a graphical user interface, web interface, or other interface available through a smart case, wireless device (e.g., app in communication with the wireless earpieces), a computing device, or other electronics configured to communicate with the wireless earpieces through a physical or wireless connection. Any number of menus, pages, icons, menus, scroll options, radio buttons, and so forth may be utilized to provide the user preferences. User preferences received through a separate device may be synchronized to the wireless earpieces.

Next, the wireless earpieces capture data and information about the user and the environment of the user based on the user preferences (step 604). The wireless earpieces include a number of sensors for measuring user biometrics, the user's environment, and other applicable information. The user preferences may specify when the distinct sensor arrays are activated to perform measurements. For example, the user preferences may specify that voice stress analysis for individuals speaking with the user is available when the wireless earpieces are worn to help the user potentially determine the truthfulness of information spoken to the user. Speech patterns may also be analyzed to determine when individuals speaking with the user may be deviating from known patterns of speech indicative of stress, lying, duress, or so forth. The user preferences may also set the wireless earpieces to monitor the user's words and actions to anticipate potential needs.

For example, any time the user uses the verbal commands or queues “What is that”, “Define [INSERT TERM TO DEFINE]”, “What is the term for [DESCRIBE TERM]”, or other user input, the legal engine may provide definitions, analysis, updates, research, or so forth.

The data and information may be utilized to perform analysis or calculations to provide valuable information, suggestions, recommendations, alerts, or other information to the user before even being requested. In one embodiment, the wireless earpieces may specifically monitor the health condition of the user.

Next, the wireless earpieces determine whether to provide automatic assistance through the legal engine (step 606). In one embodiment, the determination of step 606 may be performed automatically in response to the user preferences provided by the user. In another embodiment, the wireless earpieces may prompt the user with a question to indicate whether the user would like assistance from the legal engine. User input may also be received through tactile input, gestures near the wireless earpieces, or so forth. During any of the steps herein described any number of alerts, warnings, or indicators may be sent through the wireless earpieces (e.g., audibly, tactilely, visually, electrically, etc.) or through one or more connected devices.

In one embodiment, the user preferences may be utilized to guess or automatically determine whether the user would like feedback or digital assistance, based on the user preferences and other sensed conversations, parameters, location, position, orientation, input, feedback, commands, or so forth. Note that in sensed conversations, it is not just voice input from a user which is analyzed but also the voice input from others. As a result, automatic feedback may be provided to the user utilizing the legal engine without requiring specific requests.

In one embodiment, the user preferences may specify a user location, orientation, determined action/activity, or user input that may be detected by the sensors of the wireless earpieces to automatically provide assistance through the legal engine of the wireless earpieces. In one embodiment, the wireless earpieces may detect that the user is meeting in a deposition at a specified location retrieved from one or more calendar entries. As a result, the legal engine may audibly prompt the user to ask a number of questions in real-time to achieve a desired result. The user preferences may specify any number of keywords, gestures, head movements, or tactile input that may be utilized to provide the specified user input. The user preferences may also include a timer or time period, such as informing the user every time 10 minutes have passed to stay within a designated time period for an interview or meetings. In another embodiment, the wireless earpieces may have an order for hot chocolate ready for electronic transfer to a nearby restaurant/shop based on the previous behavior of the user. In another embodiment, the wireless earpieces may detect the user is swimming or performing yoga and may automatically begin playing a preselected playlist of music while reporting user specified biometrics. In another embodiment, the wireless earpieces may automatically prepare a message, such as a text message indicating “I am on my way to the office” in response to the location of the user (e.g., leaving a location designated as home or when leaving the gym, etc.). The user preferences may be utilized to provide enhanced legal services to clients of the user while facilitating communications and safety of the user. For example, the wireless earpieces may also text or post the user's last known location and activity for specified individuals that are trusted with that information e.g., immediate family, friends, etc.).

If the wireless earpieces determine to not provide automatic assistance through the legal engine during step 606, the wireless earpieces continue to capture data and information about the user the environment or the user based on the user preferences (step 604). Updated user preferences establishing how and when the legal engine of the wireless earpieces are utilized may be updated at any time as shown in step 602.

If the wireless earpieces determine to provide automatic assistance through the legal engine during step 606, the wireless earpieces generate automatic assistance through the legal engine utilizing the data and information from the legal services (step 608). The legal engine may function in accordance with the user preferences previously established by the user.

Next, the wireless earpieces communicate the automatic assistance to the user through the legal engine of the wireless earpieces and/or connected wireless device (step 610). In one embodiment, the legal engine may automatically report available statistics (e.g., words spoken, reference to specific terms, current heart rate, average heart rate, maximum heart rate, average speed, etc.) in response to determining the user is in a predefined location, orientation (e.g., hand held up close to the head of the user), and so forth. The legal engine may also periodically report custom information to the user based on the user preferences. For example, the custom information may include a timer, user's temperature, and an environmental temperature. In one embodiment, the legal engine of the wireless earpieces may interject to provide warnings based on determined user biometrics that are associated with a user health condition. For example, if the legal engine determines based on the user's biometrics, that the user may be overheating, the legal engine may provide a warning to the user and encourage that the user rest, request a break, or drink lots of water and seek out medical attention as needed/available.

In other embodiments, the wireless earpieces may be utilized to provide marketing or business information to the user. For example, in response to the user approaching a restaurant, applicable coupons, discounts, promotions, incentives, or other communications may be played to the user for at least the user may be made aware that such information is available. The wireless earpieces may include default preferences controlling how such information may be communicated to the user. The user preferences may also specify when, how, and where the user may be alerted of such information. The user may also allow the wireless earpieces to “listen” to applicable conversations to suggest potential restaurants, outsourcing services, marketing, or business information.

In other embodiments, the wireless earpieces may implement an action or provide automatic assistance to address a health or medical status issue associated with the user. The sensors may read various user biometrics that may be utilized by the logic (e.g., processing and comparison against user supplied or predefined thresholds) to determine the health or medical status of the user. For example, the wireless earpieces may determine the user is overheating, passed out, lethargic, drunk, slurring speech, in shock, hypertensive, in diabetic shock, dehydrated, in pain, stressed, or so forth. Any number of health or medical conditions or states may be detected by the wireless earpieces based on the applicable health factors and parameters that may be ascertained by the sensors (e.g., pulse rate, respiration rate, temperature, position, orientation, voice characteristics, blood pressure, blood chemical content, skin measurements, impact/force levels, and associated statistics, trends, etc.). The sensors of the wireless earpieces (e.g., microphone, blood monitor, optical scanners, accelerometer, gyroscope, potentiometer, heart rate monitor, or other monitoring devices) may also measure any number of other parameters, settings, conditions, thresholds, or values. The wireless earpieces may identify warning signs as well as conditions to notify the user, guardians, administrators, caregivers, or so forth.

FIG. 7 is a passive process for utilizing a legal engine in accordance with an illustrative embodiment. The process of FIG. 7 may begin by executing a legal engine for the wireless earpieces (step 702). For example, the legal engine may represent common virtual or digital assistants, such as Siri, Alex, Cortana, OK Google, Watson, or so forth provider by any number of service providers or companies. In one embodiment, the legal engine may run as a background process on the wireless earpieces that may be utilized at any time. The legal engine may also be activated based on user input, such as a voice command, tactile input, gesture, user movement, user preferences, or so forth. In other embodiments, the legal engine may be integrated with an operating system, kernel, or set of instructions available to the wireless earpieces. The legal engine may also represent an application executed by the wireless earpieces.

Next, the wireless earpieces passively collect information and data utilizing sensors of the wireless earpieces (step 702). The wireless earpieces may collect information in accordance with user preferences, settings, or other permissions of the wireless earpieces. As a result, the user may not feel that the wireless earpieces are invading the privacy of the user. The user may also specify how the information and data is saved, archived, or otherwise communicated with a wireless device or other applicable devices or systems when performing passive monitoring or analysis. In one embodiment, the wireless earpieces may analyze the speech patterns of the user. For example, the wireless earpieces may be utilized to provide feedback for users that are learning a new language, trying to improve their grammar, vocabulary, or accent, or otherwise trying to enhance their speech and language characteristics. The wireless earpieces may also be utilized to provide legal skills, such as indicating the steps for proceeding with a summary judgment motion. Similarly, the wireless earpieces may be utilized to help a user regain speech and motor functions after a stroke, heart attack, or other medical condition. For example, the user may be prompted to say a number of words, phrases, or sentences and may then be coached, corrected, or otherwise guided to make improvements based on the voice input read from the user by the microphones of the wireless earpieces.

In another embodiment, the wireless earpieces may analyze the speech of the user to determine applicable questions that the user may have. The applicable legal engine may utilize automatic speech recognition to transcribe human speech (e.g., commands, questions, dictation, etc.) into text or other formats for subsequent analysis. The legal engine may also perform natural language processing (e.g., speech tagging, noun-phrase chunking, dependency and constituent parsing, etc.) to translate transcribed text into parsed text. For example, in response to determining the user has asked “when is our next response due?”, the legal engine may retrieve applicable information from a docketing system, calendar, or other application or function to audibly play “the next response is due on May 15.” Similarly, in response to determining the user has asked about the format for the response, the legal engine may retrieve applicable information available through one or more locally stored databases, external databases, or so forth to retrieve the information for the user. The legal engine may also communicate with one or more virtual engines, such as IBM's Watson to retrieve the applicable information.

During step 704, the legal engine may also perform “question and intent analysis” to analyze parsed text. For example, parsed text may be associated with particular user commands and actions (e.g., “Tell me my heart rate”, “What are the voice stress levels in the room?”, “Set a timer for five minutes to indicate my allotted time is gone”, “Tell me when I have used the word litigation 10 times.”, etc.).

Contextual data may be collected with the one or more wireless earpieces. The contextual data may include any data collected by the wireless earpieces. This may include, for example, voice audio from the user as well as others. Thus, for example, where the user is a lawyer, audio from judges, witnesses, co-counsel, opposing counsel, parties, or others may be received and processed to provide additional context. Contextual information may also include location of a user, and/or a court docket number or other reference number identifying a legal proceeding. The contextual data may be collected from the wireless earpiece(s) as well from other electronic devices operatively connected with the wireless earpieces(s) or associated with the user. For example, in one embodiment, for example, calendar information from a mobile device or other computing device in operative communication with the wireless earpiece(s) may be used to identify a court docket number. Filings, transcripts, or other records which may accessed through online databases may be used to provide additional context. Thus, information about the particular case that the lawyer has a hearing, deposition, trial, or other legal proceeding is available to inform the artificial intelligence. In one example, the legal proceeding may form a part of a query made by the wireless earpiece(s) to an online engine which may then collect the other information which may be present in court databases, e-discovery records, on the user's computer network or cloud-based platforms used by the user and documents contained thereon including notes, outlines, and other documents, or information stored elsewhere. Thus, contextually aware information may be provided.

Next, the wireless earpieces provide feedback to the user utilizing the legal engine (step 706). In one embodiment, the feedback may be provided in response to a user input or request. In another embodiment, the feedback may be automatically provided to the user. In one example, the feedback of step 706 may be applicable to the language analysis performed during step 404. For example, the legal engine may indicate that the properly way to challenge the legality of detention or arrest in Latin is “habeas corpus” and provide phonetical description (e.g., hey-bee-us-core-pus). Similarly, the user may receive audible instructions on how to say difficult terms or phrases utilizing grammatical, phonetic, accent, or other applicable speech tutorials. A phonetic spelling may also be sent to a wireless device in communication with the wireless earpieces (e.g., “/‘he [symbol] bi. [symbol] s ’k [symbol] :rp [symbol] s/”). In another example, if the user asks in conversation, “Where is Julie?”, the legal engine may look up applicable mapping information during step 404 that may have been previously shared with the user by Julie (e.g., Find Friends, Glympse, Google Maps, Waze, etc.) for communication to the user, such as Julie is 2.3 miles away from the courthouse and headed in your direction at 35 mph.

It is noted that when in passive mode, the availability of useful information to the user may be presented in various ways. For example, audio tones may serve as notifications to the user to indicate the availability of the information. The user may then provide user input to the wireless earpieces to hear the audio. The user input may be of any number of forms. Thus, for example, a lawyer during a legal proceeding may ask for, “One moment to confer.” Once granted, the lawyer may then listen the information about which they were notified. This may include suggestions for additional arguments, additional lines of questioning, providing legal precedent, identifying errors made by the lawyer or opposing counsel which should be corrected, or other information of use to the user.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

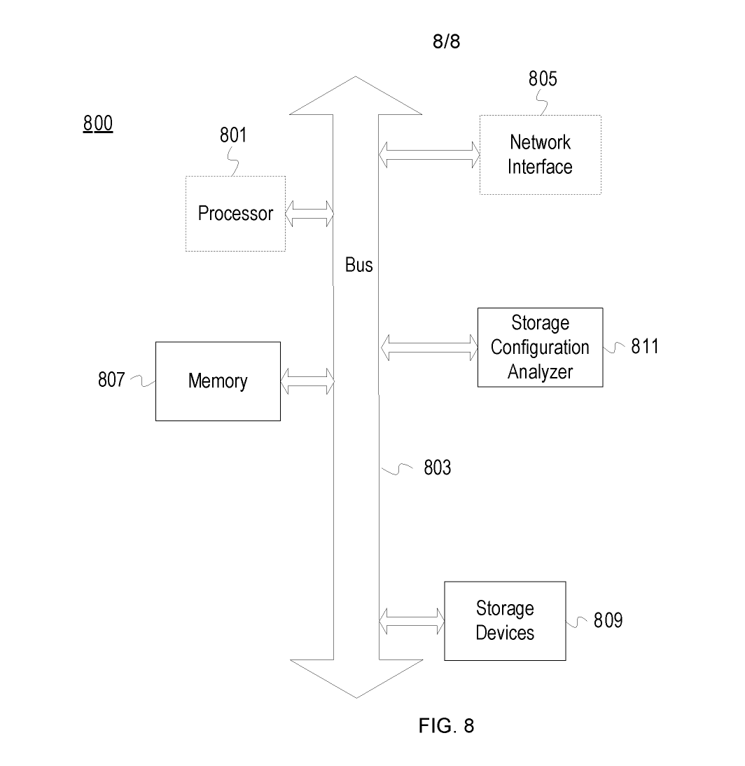

FIG. 8 depicts a computing system 800 in accordance with an illustrative embodiment. For example, the computing system 800 may represent a device, such as the wireless device 204 of FIG. 2. The computing system 800 includes a processor unit 801 (possibly including multiple processors, multiple cores, multiple nodes, and/or implementing multi-threading, etc.). The computing system includes memory 807. The memory 807 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 803 (e.g., PCI, ISA, PCI-Express, HyperTransport®, InfiniBand®, NuBus, etc.), a network interface 806 (e.g., an ATM interface, an Ethernet interface, a Frame Relay interface, SONET interface, wireless interface, etc.), and a storage device(s) 809 (e.g., optical storage, magnetic storage, etc.). The system memory 807 embodies functionality to implement all or portions of the embodiments described above. The system memory 807 may include one or more applications or sets of instructions for implementing a legal engine to communicate with one or more wireless earpieces. The legal engine may be stored in the system memory 807 and executed by the processor unit 802. As noted, the legal engine may be similar or distinct from a legal engine utilized by the wireless earpieces. The legal engine may also represent one of multiple instances utilized by distinct electronic devices to perform the embodiments herein described as an integrated unit. Code may be implemented in any of the other devices of the computing system 800. Any one of these functionalities may be partially (or entirely) implemented in hardware and/or on the processing unit 801. For example, the functionality may be implemented with an application specific integrated circuit, in logic implemented in the processing unit 801, in a co-processor on a peripheral device or card, etc. Further, realizations may include fewer or additional components not illustrated in FIG. 8 (e.g., video cards, audio cards, additional network interfaces, peripheral devices, etc.). The processor unit 801, the storage device(s) 809, and the network interface 805 are coupled to the bus 803. Although illustrated as being coupled to the bus 803, the memory 807 may be coupled to the processor unit 801. The computing system 800 may further include any number of optical sensors, accelerometers, magnetometers, microphones, gyroscopes, temperature sensors, and so forth for verifying user biometrics, or environmental conditions, such as motion, light, or other events that may be associated with the wireless earpieces or their environment.

The memory 807 may include any number of legal databases that may be utilized to perform all or portions of the illustrative embodiments. The processor 801 and the memory 807 may also be utilized to access legal services that may similarly facilitate retrieving applicable information or implementing various actions.

The features, steps, and components of the illustrative embodiments may be combined in any number of ways and are not limited specifically to those described. In particular, the illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. A method for implementing a legal assistant utilizing wireless earpieces, the method comprising:
receiving a request from a user to be implemented by wireless earpieces;
executing a legal assistant on the wireless earpieces to interpret the request and contextual data associated with the request into a query;
retrieving information associated with the query from one or more legal databases accessible to the wireless earpieces; and
implementing an action to fulfill the request utilizing the information through the legal engine.

2. The method of claim 1, wherein the request is user input specified by a user of the wireless earpieces for activating the legal engine.

3. The method according to claim 1, wherein the legal engine is implemented independently by the wireless earpieces, and wherein the one or more legal databases are stored on a memory of the wireless earpieces.

4. The method according to claim 1, wherein the request is receivable by the wireless earpieces whether the wireless earpieces are worn or not.

5. The method according to claim 1, wherein the request is fulfilled by sending one or more commands to an associated wireless device.

6. The method according to claim 1, wherein the action includes playing the information to a user of the wireless earpieces utilizing one or more speakers of the wireless earpieces.

7. The method of claim 2, wherein the user input is any of a gesture, voice input, or tactile input specified by the user.

8. The method according to claim 1, further comprising:
searching for the request in response to one or more conditions, locations, or user input.

9. The method of claim 1, further comprising:
recording audio content through one or more microphones of the wireless earpieces in response to receiving the request.

10. The method of claim 1 wherein the contextual data comprises sensor information including voice audio from at least one person other than the user detected at one or more microphones of the wireless earpieces.

11. The method of claim 1 wherein the contextual data comprises location of the user.

12. The method of claim 1 wherein the contextual data comprises a court docket number identifying a case associated with the query.

13. The method of claim 1 wherein the contextual data comprises:
sensor information including voice audio from at least one person other than the user detected at one or more microphones of the wireless earpieces; and
a court docket number identifying a case associated with the query.

14. A method for implementing a legal assistant utilizing wireless earpieces, the method comprising:
providing a set of wireless earpieces wherein at least one of the wireless earpieces comprises a frame for fitting in an ear of a user, a plurality of sensors measuring biometrics and actions associated with the user, a logic engine operatively connected to the plurality of sensors and configured to execute a legal assistant, and a transceiver operatively connected to the logic engine;
collecting contextual data from the set of wireless earpieces using the plurality of sensors and from one or more additional electronic devices associated with the user;
executing a legal assistant on the wireless earpieces to interpret the contextual data into a query;
retrieving information associated with the query from one or more legal databases accessible to the wireless earpieces; and
generating audio at the set of wireless earpieces to convey the information to the user.

15. The method of claim 14 wherein the contextual data comprises voice audio from at least one person other than the user detected at one or more microphones of the wireless earpieces.

16. The method of claim 14 wherein the contextual data comprises location of the user.

17. The method of claim 14 wherein the contextual data comprises a court docket number identifying a legal proceeding.

18. The method of claim 14 further comprising making the user aware of the availability of the information and receiving permission from the user through the set of wireless earpieces to convey the information to the user via the audio.
